(19) United States
(12) Patent Application Publication
(10) Pub. No.: US 2008/0222388 A1
(43) Pub. Date: Sep. 11, 2008

(54) Simulation of processor status flags

(75) Inventor: Darek Mihocka, Mercer Island, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,638

(22) Filed: Mar. 5, 2007

(51) Int. Cl. G06F 15/00

(52) U.S. Cl. 712/3

(57) ABSTRACT

The dynamic efficient and accurate simulation of processor status flags is described. One exemplary embodiment includes simulation of processor status flags of a first CPU type on a second CPU type using simple arithmetic operations to calculate status flags in parallel, and by keeping an intermediate state that allows efficient calculation of status flags when they are needed. In this way, sufficient intermediate state exists to generate desired status flags either directly or with a simple operation.

### BACKGROUND

A processor generally has registers to arithmetically manipulate binary numbers according to instructions. To record the result of an arithmetic manipulation, a processor may use a status flag or a condition code register comprising multiple status flags. For example, a common instruction set architecture is the x86 architecture from Intel. The x86 architecture uses Zero, Sign, Carry, Overflow, Adjust and Parity flags to denote the corresponding aspects of the arithmetic operation of a register. In this instruction set architecture, if the operation is an addition of two numbers, and the sum exceeds the size of the register, then the Carry flag will be set to indicate a carry-out bit representing the excess value in the addition. This carry flag may be used in a compare and branch instruction sequence where the processor may branch to some other instructions based on the result of the arithmetic operation.

Instruction set architectures may be emulated or simulated on other machines. For example, the x86 architecture described above may be simulated on a PowerPC instruction set architecture from Motorola. This is often referred to as simulating a guest processor on a host processor. The terms “host” and “host processor” are used interchangeably to refer to the actual physical microprocessor that is running the virtual machine or simulation software, and the terms “guest” and “guest processor” are used interchangeably to refer to the instruction set which is being simulated by that software.

For virtual machines and simulators which emulate a microprocessor instruction set, it is often difficult to efficiently and correctly emulate the arithmetic status flags. One reason for this difficulty is that, when simulating a guest processor of one instruction set architecture on a host processor of another instruction set architecture, the instructions and status flags typically do not fully agree. For example, there may be some variation on what conditions actually trigger a carry flag. Also, instructions may differ in how they are used. For example, an arithmetic operation on an x86 architecture has a size associated with the operation, like an 8-bit add, or a 16-bit add, while a corresponding PowerPC add operation implicitly happens at the width of the register used in the addition.

In some cases, the same instruction set architecture may be simulated at a different bit width. For example, a 32-bit instruction set may be simulated on a 64-bit instruction set host processor of the same, or even a different, instruction set architecture. Furthermore, in a conventional approach, when a 32-bit instruction set is simulated on a 64-bit instruction set host processor, the 32-bit values are shifted to the higher half of the 64-bit host processor, and the rest of the 64-bit register is masked in order to set the host processor status flags according to their equivalent in the 32-bit guest instruction set architecture.

Various methods have been proposed to simulate the calculation of status flags via a host processor. One method of simulating a microprocessor instruction set is to preserve a full state of operators and operands, and then to use at least one operand and the operator to generate status flags as needed. However, this may result in storing excess state and in effect causing simulation inefficiency as a result of storing the excess state. Another method involves utilizing programming in a high-level language such as C or C++ to calculate the status flags one at a time, generally as one or more unique expressions per flag being calculated. However, such programming often compiles into multiple host instructions. As a result, what is originally a one-clock cycle instruction can end up taking dozens of cycles to simulate, even when running on the same host processor, which may greatly slow down operating speeds.

Methods utilizing low-level simulations may benefit from more efficient instructions in assembly language, and from the fact that they are essentially hand coded and not compiled. However, these types of simulations generally make a direct mapping of the status flags between the guest and host processor, which also may unduly impact performance. Furthermore, as newer versions of the instruction set come out, there may be deletions of instructions from the guest processor, and the host processor thus may not be able to emulate them directly. Furthermore, low-level implementations may result in simulation errors when page faults occur, as the host processor may have already changed the status flags by the time it is aware that a fault occurred.

### SUMMARY

Accordingly, an efficient and accurate simulation of processor status flags is described below in the Detailed Description. For example, in one embodiment, simulation of processor status flags of a first CPU type on a second CPU type may be implemented by adding two vectors and performing an exclusive OR operation between the two vectors, performing an exclusive OR operation between the result of the addition and the result of the exclusive OR operation of the two vectors to generate an intermediate state, and setting at least one status flag based on the intermediate state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a process flow of a method for simulation of processor status flags.

FIG. 2 shows a process flow depicting examples of status flags that may be set during performance of the embodiment of FIG. 1.

FIG. 3 shows a schematic depiction of an adder circuit.

FIG. 4A shows a truth table comparing a binary addition and an exclusive OR operation.

FIG. 4B shows a truth table comparing a binary addition with carry in bits and an exclusive OR operation.

FIG. 5 shows a schematic depiction of an embodiment including a computing device.

FIG. 6 shows a schematic depiction of an embodiment set of registers in a host processor.

### DETAILED DESCRIPTION

The embodiments below describe simulation of processor status flags for a guest processor on a host processor as is described in this Detailed Description. For example, in one embodiment, simulation of processor status flags of a guest processor type on a host processor may be implemented by using the result of an arithmetic operation to calculate status flags in parallel using ordinary arithmetic operations easily expressible in various programming languages, and by keeping only sufficient intermediate state to allow efficient calculation of status flags on an as-needed basis, without having to store excess state of the simulated guest processor, while using less processing resources, and while reducing simulation flaws due to incorrect processor state resulting from page faults, etc. The intermediate state approach described herein is not restricted to hardware emulation of a guest instruction set, as it also may be used in software-only implementations independent of the host processor on which the software is running.

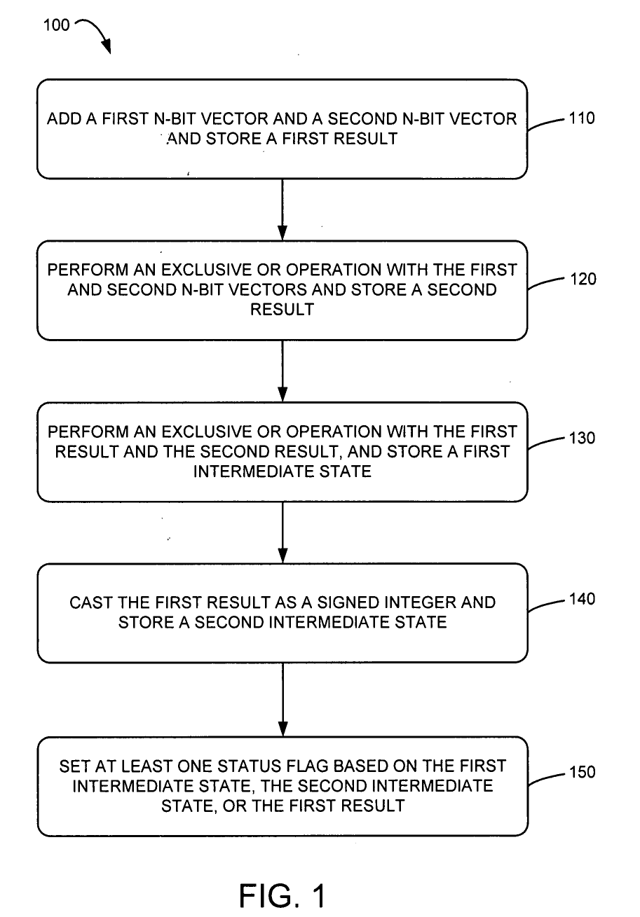

FIG. 1. depicts an embodiment of a method 100 for simulating the calculation of processor status flags in a guest processor. Before proceeding with the description of FIG. 1, it will be appreciated that the embodiments described in detail below may be implemented, for example, via computer-executable instructions or code, such as programs, stored on a computer-readable storage medium and executed by a computing device. Generally, programs include routines, objects, components, data structures, and the like that perform particular tasks or implement particular abstract data types. The term “program” as used herein may connote a single program or multiple programs acting in concert, and may be used to denote applications, services, or any other type or class of program. Likewise, the terms “computer” and “computing device” as used herein include any device that electronically executes one or more programs, including but not limited to personal computers, servers, laptop computers, hand-held devices, cellular phones, micro-processor-based programmable consumer electronics and/or appliances, routers, gateways, hubs and other computer networking devices.

Turning again to FIG. 1, this figure shows a flow diagram of one exemplary embodiment of a method 100 of simulation of processor status flags. Method 100 includes, at 110, adding a first n-bit vector and a second n-bit vector and storing a first result. The add operation in block 110 is agnostic to the status flags generated by the operation, and therefore simple addition operators may be used to reduce processing cycles.

As described in embodiments herein, the n-bit vectors may be single bit vectors, multiple bit vectors, memory locations, registers, portions of registers, etc. In some embodiments, the n-bit vectors will be the same width as the guest instruction set being simulated. For example, the registers may be 64-bits wide and the guest instruction set may be 64-bits wide.

Additionally, the n-bit vectors may be the same width as the guest and host instruction set architectures. As an example, the n-bit vectors would be the same width as both architectures if the host and guest instructions sets were 64-bits and the n-bit vectors are 64-bits wide. Other combinations of n-bit vector width, host instruction set width and guest instruction width are within the teachings of this disclosure. Some embodiments may involve register-to-register arithmetic operations, register-to-memory arithmetic operations, and in architectures that allow it, memory-to-memory arithmetic operations. Alternatively, other embodiments may utilize any other combination of registers, memory, variables, machine readable code code, etc. Additionally, embodiments may be implemented in software, hardware, machine readable code, combinations thereof, etc., and are not limited to any one implementation.

In some embodiments, the guest processor and host processor may be different types of architectures in terms of Reduced Instruction Set Computing (RISC) and Complex Instruction Set Computing (CISC). Example RISC architectures include Alpha, ARC, ARM, AVR, MIPS, PA-RISC, PIC, PowerPC Architecture, SPARC, among others. Example CISC architectures include Intel and AMD x86, the Motorola 68000 family, PDP-11, System/360, and VAX instruction set architectures, as examples. Additionally, embodiments may be implemented in high-level computing languages like C/C++, or any other high-level language, or even in low-level languages such as assembly language.

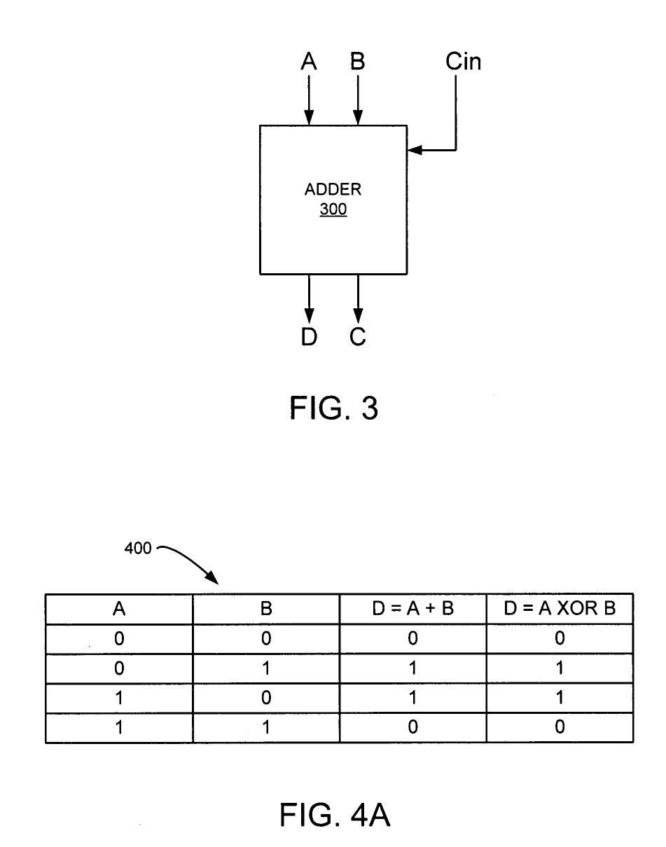

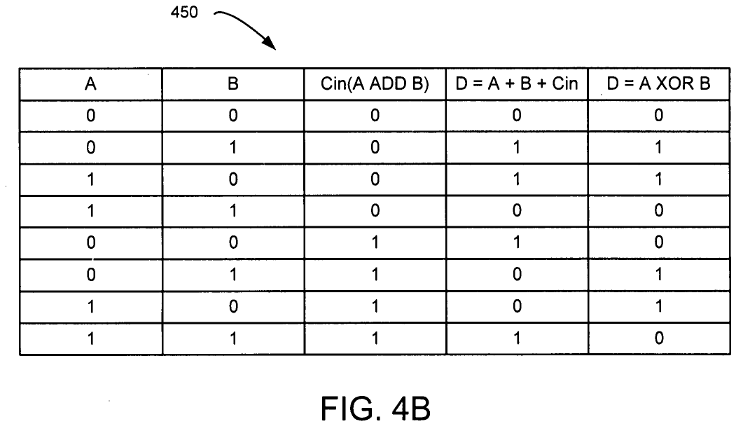

Continuing with FIG. 1, method 100 next includes, in block 120, performing an exclusive OR operation with the first and second n-bit vectors and storing a second result. As will be clear in reference to FIG. 3-FIG. 4B below, an embodiment may use an arrangement of the exclusive OR operator and a simple addition to create an intermediate state sufficient to either derive some status flags, or that actually includes some status flags as certain bits resulting from the intermediate state.

Following performing the exclusive OR with the first and second n-bit vectors, method 100 next includes, as shown in block 130, performing an exclusive OR operation with the first result and the second result, and storing a first intermediate state. In some embodiments, this first intermediate state represents a carry vector that may be used with simple arithmetic operations to derive status flags according to embodiments herein and as encompassed in the appended claims concluding this disclosure. It will be appreciated that the term “result” as used herein may refer to the result of an operation performed on the first and/or second n-bit vectors, while the term “intermediate state” may refer herein to a number derived from the first and/or second results.

Continuing with FIG. 1, method 100 next includes casting the first result as a signed integer and storing a second intermediate state in block 140. In block 150, method 100 then sets at least one status flag based on at least one of the first intermediate state, the second intermediate state, and the first result. As described below, the stored first result and first and second intermediate states contain sufficient state for deriving all of the above-referenced status flags directly from these results and intermediate states.

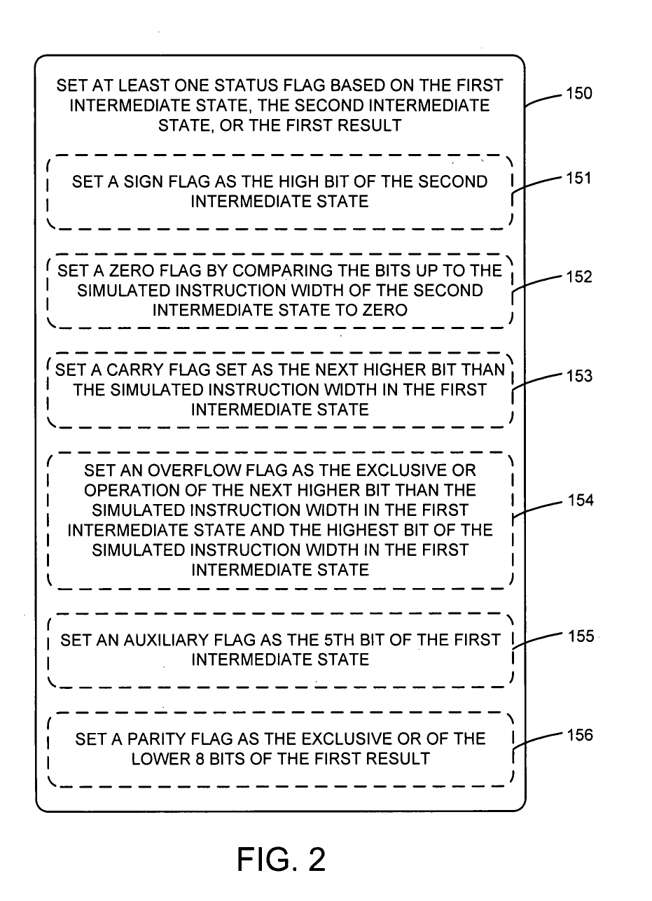

Referring now to FIG. 2, specific examples of methods for setting various status flags are illustrated. As will be seen, a benefit of storing the first result and the intermediate states as disclosed herein is that arithmetic flags may be calculated in parallel, thereby increasing runtime efficiency. In the specific example of FIG. 2, all six of the above-referenced arithmetic flags can be calculated from the first result, and the first and second intermediate states. Alternately, the first result may be stored in a separate register, variable, or memory location to represent a third intermediate state to calculate a Parity flag.

First regarding the second intermediate state, the Sign and Zero flags may be derived from this state. As indicated in block 151, the Sign flag, (or equivalent flags in other instruction sets), may be set as the high bit of the second intermediate state. Further, as indicated at optional block 152 a Zero flag (or equivalent flags in other instruction sets) may be generated by comparing the bits up to the simulated instruction width of the second intermediate state to zero.

Next regarding the first result, as indicated in block 156, a Parity flag may be generated by performing an exclusive OR of the lower 8 bits of the first result in block 110. In this embodiment, parity is calculated based on the number of “1” bits in the bottom 8 bits of the arithmetic result. If there is an even amount of “1” bits in the bottom 8 bits of the first result, a Parity flag can be set to 1, and if there is an odd amount, the Parity flag can be set to 0. For example, the bits may be added one at a time in a loop, a 256-byte lookup table comprising bytes holding a 0 or a 1 may be used, or other sequences of arithmetic operations may be used. In one embodiment, 3 sequential exclusive OR operations may be used. The upper 4 bits of an 8-bit number may be shifted and an exclusive OR operation performed between the shifted 4 bits and the original 4 lower bits of the 8-bit number. Then, the upper 2 bits may be shifted and another exclusive OR performed in the same manner, in turn followed by a shift and exclusive OR of the two 1 bit parts of the resulting 2 bit number, resulting in a 1 bit number that may then be complemented (i.e. inverted) to represent the Parity of the original 8-bit number. For example, if the result of the exclusive OR of the two 1 bit numbers is a 0, then the original 8 bits comprised an equal amount of “1” bits. Therefore, this result may be complemented to 1 and the Parity flag set as this complemented result.

In some embodiments, the complemented result may be in a register that may be masked to generate only the single bit value of the complemented result. In other embodiments, the Parity flag can be set directly with the value of the single bit value of the complemented result without a separate masking step. As an example, the equivalence (EQV) instruction in PowerPC assembly language may be used to perform the final exclusive OR between the final two bits. This instruction performs the exclusive OR between two bits, inverts the result of the exclusive OR, and stores the single bit result in a destination, therefore providing the complemented single bit result without a separate masking step.

Next, the first intermediate state may be used to calculate Carry, Auxiliary Carry, and Overflow flags in an X86 instruction set, and/or equivalent flags in other instruction sets. For example, the first intermediate state may be used to generate a Carry flag, or equivalent flags, by selecting the next higher bit than the simulated instruction width, as illustrated in block 153 of FIG. 2. For example, if the guest processor, or, a first CPU type, that comprises a 32-bit instruction set architecture, and the host processor, or second CPU type, is a 64-bit instruction set architecture, then the next higher bit than the simulated instruction width is the 33rd bit of the host processor. The 33rd bit of the host processor is the carry-out bit from the 32nd bit of the guest processor, and therefore designates the carry bit used to generate a Carry flag.

Alternate embodiments may use the first intermediate state to represent different values, but the underlying calculations of each representation can still be used to generate a first intermediate state as used herein. In register-level operations, equivalent calculations can represent different values, but still operate according to the same bit-wise principles between the registers. For example, a first intermediate state may represent a carry vector defining either carry-in bits or carry-out bits. Although these bits represent the same value, they are relative to different bits of the register in the base arithmetic operation and an extra bit may be needed, as explained below.

In the case of a guest processor and a host processor of the same instruction or register width, an intermediate state may be used in various ways depending on how it represents the carry information. In a first example, the intermediate state can reside in a register representing carry-in bits, and thus the highest bit of the intermediate state may represent the carry-in bit of one higher bit in a base calculation. In this example, a 64-bit host processor may emulate a 64-bit guest processor, and the intermediate state may be stored in one 64-bit register because the carry-in bit for a position of the intermediate state register represents one higher-bit position in the underlying arithmetic operations register. But embodiments are not so limited to the same register, instruction or variable width. A second example for identical instruction widths between the guest and host processor, may store additional bits in one or multiple other registers, such as the higher bits of the register where the first result is stored since it only uses 8 bits of that register to generate the Parity flag. Some embodiments may utilize other instruction widths, but may still benefit from generating the first intermediate state and therefore being able to derive a Carry flag and equivalents out of the intermediate state.

In some embodiments, the first intermediate state resulting from block 130 also may be used to derive an Overflow flag, or equivalent flags, by performing an exclusive OR operation of the next higher bit than the simulated instruction width and the highest bit of the simulated instruction width, as illustrated in block 154 of FIG. 2. In the present embodiment, this would involve performing an exclusive OR between the 33rd bit and the 32nd bit in the first intermediate state. Some embodiments may utilize other instruction widths, and may still benefit from generating the first intermediate state and therefore being able to derive an Overflow flag and equivalents out of the intermediate state.

Additionally, in block 155, the first intermediate state may be used to generate an Auxiliary carry flag, otherwise known as an Adjust flag, by setting the Auxiliary carry flag as the 5th bit of the first intermediate state. Some embodiments may utilize other instruction widths, and may still benefit from generating the first intermediate state and therefore being able to derive an Auxiliary flag and equivalents out of the intermediate state.

According to the present embodiment, sufficient intermediate state is generated using simple arithmetic operators in order to derive status flags on an as-needed basis. Furthermore, the present intermediate states can be calculated without requiring inefficient techniques including preserving total state, without mapping status flags one-to-one between the guest and host processors, and without calculating flags one-by-one for each arithmetic operation and therefore reducing inefficiency. Additionally, this approach reduces certain simulation flaws resulting from page faults due to host processor state changing after a fault happens but before it is detected.

FIG. 3 shows a schematic depiction of a 1-bit full adder circuit 300. Adder circuit 300 is adapted to receive input A and input B and add them together to generate a result D. In addition, adder circuit 300 also includes a carry-in (Cin) input, and a carry output C. Adder 300 may generate result D based on adding input A, input B, and the Cin bit. If the addition results in a carry-out bit, adder 300 generates C bit representing the carry-out of the addition. Similarly, adder 300 may operate without the carry-in input, and therefore generate the result D based on inputs A and B. In this implementation, it may still utilize carry-out bit C and function as a “half-adder”.

In alternate implementations, adder 300 may operate without any carry bits and therefore function as a simple adder. Alternately, multiple 1-bit full adders such as adder 300 may be configured so the carry-out bit of each successive adder functions as the carry-in bit of the next higher adder. This “ripple carry” configuration allows the same basic adder principles to apply to a multiple-bit vector. Various other configurations may be used to generate varying adder properties.

Referring now to FIG. 4A, a truth table 400 comparing a binary addition and an exclusive OR operation is illustrated. The first two columns of truth table 400 can correspond to the inputs A and B of adder 300. According to truth table 400, a simple addition of A and B without carry is represented in the third column, resulting in D. The third column therefore also represents output D of adder 300 when the adder is operating without any carry-in or carry-out bits. In this manner, when A and B are the same value, D is a zero. When A and B are different values, for example when A is 0 and B is 1, then D is also 1.

The fourth column of truth table 400 represents an exclusive OR between input A and input B. In similar fashion to the simple addition without carry bits between A and B, when A and B are the same value, D is a zero. When A and B are different values, for example when A is 0 and B is 1, then D is also 1. According to the results shown in truth table 400, an addition and an exclusive OR appear to be the same operation. When the addition operation receives and uses a carry-in bit, we see a difference between the results of the add operation and the exclusive OR operation.

FIG. 4B shows a truth table 450 comparing a binary addition with carry in bits and an exclusive OR operation. The third column of truth table 450 represents a carry-in bit for the operation A ADD B, as represented by the adder 300 in FIG. 3. The fourth column in truth table 450 includes the result of the addition operation of inputs A and B, but now includes the carry-in bit from the third column of truth table 450. The fifth column of table 450 represents an exclusive OR operation between inputs A and B, and therefore contains the results of the fourth column of truth table 400 above, but repeated.

Truth table 450 illustrates that when the carry-in bit is considered in the addition operation, then the result D is the same as the exclusive OR of input A and B when the carry-in bit is zero. Truth table 450 illustrates that when the carry-in bit is considered in the addition operation, then the result D is different from the result of the exclusive OR of input A and B when the carry-in bit is non-zero. An interesting aspect of truth table 450, is that the carry-in vector in the third column of the table, or any single bit of that vector, can be derived from an exclusive OR of the fourth and fifth columns of the table. Stated differently, by performing an addition between two n-bit vectors, and then by performing an exclusive OR between the same two vectors, a partial intermediate state is generated. By performing another exclusive OR between the result of the addition of the two n-bit vectors and the result of the exclusive OR of the two n-bit vectors, the carry-in vector, which is saved in method 100 as the first intermediate state, can be derived and used to calculate Carry, Overflow and Auxiliary flags, as described above. While truth tables 400 and 450 show A, B and C as one-bit vectors, it will be appreciated that the relationships shown in these truth tables also apply to any n-bit vector.

According to truth table 450 in FIG. 4B, sufficient intermediate state can be generated using arithmetic between two n-bit vectors in order to derive status flags when desired. In similar fashion to the embodiments in FIG. 1, the present intermediate state can be calculated without requiring inefficient techniques including preserving total state, without mapping status flags one-to-one between the guest and host processors, and without calculating flags one-by-one for each arithmetic operation and therefore reducing inefficiency. Also, this approach may help to reduce simulation flaws in similar fashion to embodiments described with reference to FIG. 1 and other embodiments.

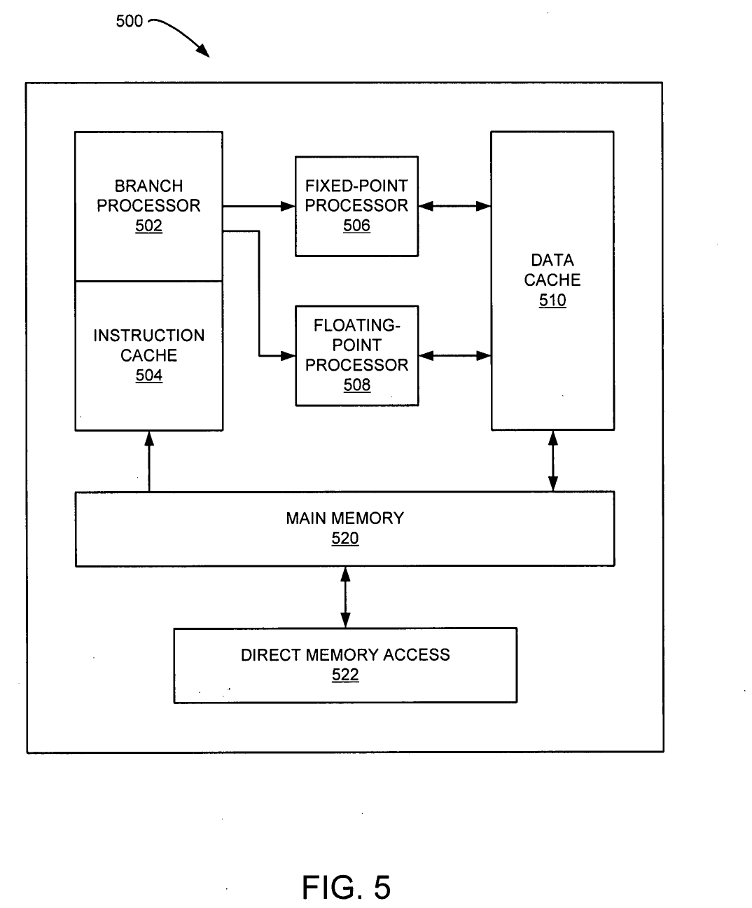

FIG. 5 shows a schematic depiction of an embodiment including a computing device 500 which illustrates a PowerPC architecture. It will be appreciated that this architecture is shown for illustration purposes, and that other embodiments may include or be implemented on any other suitable architecture using any combination of registers, memory, variables, machine executable code, and the like.

Computing device 500 includes branch processor 502 in communication with instruction cache 504. Branch processor 502 is also coupled with fixed-point processor 506 and floating-point processor 508. Both fixed-point processor 506 and floating point processor 508 are also coupled with data cache 510 that may store data for quick retrieval. Main memory 520 is in communication with data cache 510 and instruction cache 504. Main memory 520 typically stores data for a longer time that data cache 510, but main memory 520 is also typically slower to access, so data being actively used is stored in data cache 510 to improve efficiency. Computing device 500 is also represented with direct memory access functional block 522. Other embodiments including computing devices may have various combinations, inclusive or exclusive, or even alternate functional blocks, to those illustrated in FIG. 5. 100431 FIG. 5 is therefore an example non-limiting computing device 500. Computing device 500 includes sequencing and processing controls for instruction fetch, instruction execution, and interrupt actions. Instructions that computing device 500 can execute include branch instructions to be executed in branch processor 502, fixed-point instructions to be executed in fixed-point processor 506, and floating-point instructions to be executed in floating-point processor 508. Other embodiments may use different architectures and distribute instructions accordingly.

Some embodiments may comprise a computer readable medium having computer executable code thereon for simulating processor status flags of a first CPU on a second CPU. For example, an embodiment may comprise executable code in instruction cache 504 to cause the second CPU, or computing device 500, to perform an arithmetic operation involving a first n-bit variable and a second n-bit variable, store the result of the arithmetic operation, generate a carry vector representing the carry-in bits from the arithmetic operation, generate at least one of a Zero flag, a Sign flag, and a Parity flag from the result of the arithmetic operation, and to generate at least one of a Carry flag, an Overflow flag, and an Auxiliary Carry flag from the carry vector, as described above.

In some embodiments, instructions in instruction cache 504 that when run on computing device 500, cause the computing device 500 to perform an exclusive OR with the result of the arithmetic operation and the carry vector in order to generate at least one of a Carry flag, an Overflow flag, and an Auxiliary Carry flag.

The present embodiment may also set a Carry flag as the 33^{rd} bit of the result of the exclusive OR, an Overflow flag is set as the exclusive OR of the 33^{rd} and 32^{nd} bits of the result of the exclusive OR involving the arithmetic operation and the carry vector, and an Auxiliary Carry flag is set as the 5^{th} bit of the carry vector. Additionally, the first CPU or simulated instruction set, may be an x86 instruction set, and the second CPU, or computing device 500, may be PowerPC, but embodiments are not so limited.

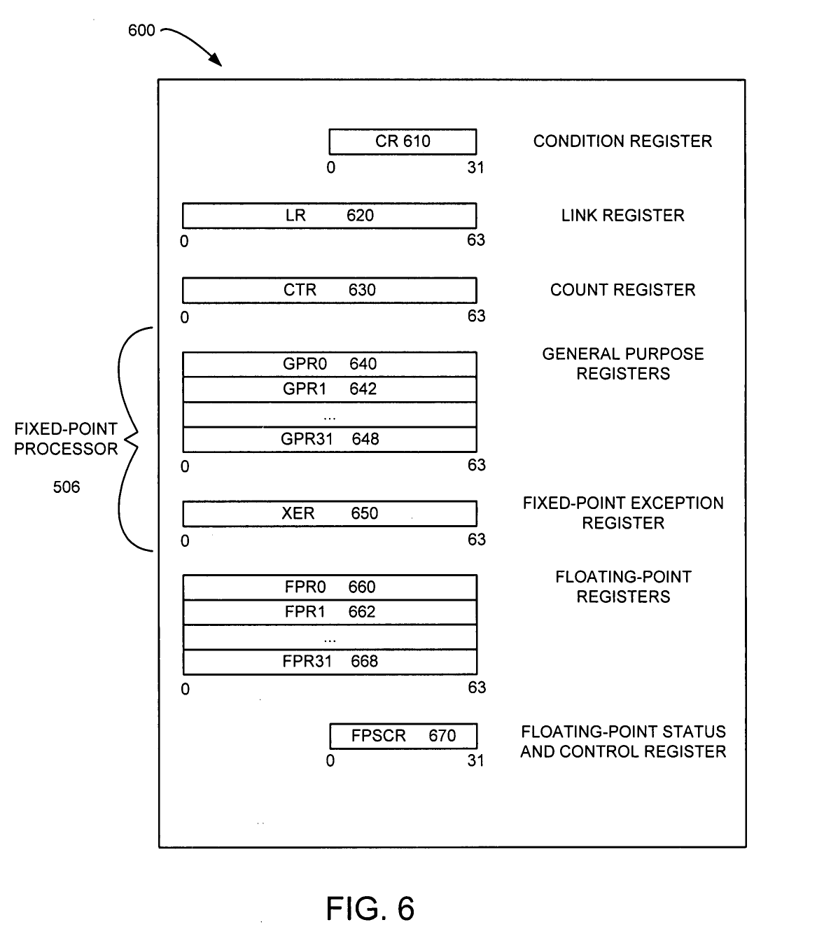

FIG. 6 shows a schematic depiction of an embodiment set of registers 600 in a host processor such as the computing device in the embodiment 500 shown in FIG. 5. These embodiment registers include a condition register 610, a link register 620, a count register 630, general purpose registers 640-648, fixed-point exception register 650, floating-point registers 660-668, and floating-point status and control register 670. Other embodiments may have alternate registers, a subset of these registers, but are not otherwise limited to those illustrated in FIG. 6.

General purpose registers 640-648, and fixed-point exception register 650, may reside in fixed-point register 506 on computing device 500. General purpose registers 640-648 may be used to generate sufficient intermediate state using simple arithmetic operators in order to derive status flags when desired, similar to n-bit vectors, memory locations, and other registers as disclosed and described in the embodiments above. Furthermore, the present intermediate state can be calculated without requiring inefficient techniques including preserving total state, without mapping status flags one-to-one between the guest and host processors, and without calculating flags one-by-one for each arithmetic operation, thereby reducing inefficiency. Additionally, this approach may help to reduce certain simulation flaws resulting from page faults due to host processor state changing after a fault happens but before it is detected.

According to one embodiment, a host computer system, such as computing device 500, may emulate a guest instruction set architecture. The host computer system may include a first general purpose register 640 to add a first number and a second number and store a first result. The host computer system may also comprise a second general purpose register 642 to perform an exclusive OR operation with the first and second numbers and store a second result.

As an example, general purpose registers 640 and 642 may be used to implement aspects of the method described in FIG. 1, as well as similar aspects of other embodiments. Additionally, the method described with reference to FIG. 1 may use the simple addition and exclusive OR operations shown with reference to the truth tables in FIG. 4A-4B, to generate intermediate state sufficient to derive status flags when needed.

Additionally, host computer system may comprise a first memory location to store a first intermediate state vector, wherein the intermediate state vector is a third result of an exclusive OR operation between the first result stored in the first general purpose register 640 and the second result stored in the second general purpose register 642. The present embodiment may also comprise a second memory location to store a second intermediate state vector, wherein the second intermediate state vector is the first result in the first general purpose register 640 cast as a signed integer. The present embodiment may also include a third memory location to store a third intermediate state vector, wherein the third intermediate state vector is the result stored in the first general purpose register 640.

In some embodiments, the host computer system may further comprise a Sign flag to be set as the high bit of the second intermediate state vector, a Zero flag to be set as the result of a comparison between the third intermediate state vector and zero, and a Parity flag to be set as the exclusive OR of the lower 8 bits of the third intermediate state vector. In some embodiments, the host computer system may embody the third memory location as a lookup table.

Additionally, in some embodiments the host computer system may further comprise a Carry flag to be set as the 33^{rd} bit of the first intermediate state vector, an Overflow flag to be set as the exclusive OR of the 33^{rd} and 32^{nd} bits of the first intermediate state vector, and an Auxiliary flag to be set as the 5^{th} bit of the first intermediate state vector. Other embodiments may utilize different bits of the intermediate state vectors within the principles of this disclosure as encompassed in the appended claims.

Accordingly, embodiments may generate arithmetic status flags, such as the 6 x86 arithmetic status flags, by storing an intermediate state sufficient to calculate any of the status flags but only calculating the status flags as desired. For example, the Zero, Sign, and Parity flags can all be derived by the stored result of the last arithmetic operation, and the Carry, Overflow, and Auxiliary flags can be derived by storing away the carry-in/carry-out vector of that result. Other embodiments may utilize an intermediate state and arithmetic operations to calculate other status flags as needed.

Some embodiments may be implemented in high-level C/C++ as a sequence of assignment operations and exclusive OR operations to the intermediate state. Other embodiments may similarly be implemented in assembly language, or any computing language that can generally manipulate the intermediate state in similar fashion. Theoretically, some embodiments may sufficiently use two general purpose registers in assembly language, or two integer variables in higher level programming languages to implement the intermediate flag states. In some situations, three general purpose registers or variables may be used in order to support guest instructions that do not update all arithmetic flags at once.

For example, certain x86 instructions only update a Zero flag but do not update a Sign flag. It is therefore possible to put the x86 processor state into a condition where both the Sign and Zero flags are set, which is not possible for a simple add with carry instruction. In this situation, the last calculated arithmetic value can be split across two general purpose registers to prevent this false condition. In embodiments simulating a 32-bit guest on a 32-bit host, a Sign bit state may be moved into upper unused bits of the general purpose register holding the parity information.

Embodiments of this disclosure can operate with instruction level parallelism, can provide greater accuracy due to a delayed commit and evaluation of flags state, provide greater portability due to the use of simple integer operations, and can also provide readability and maintainability due to the straight forward simulation approach described herein.

It will be appreciated that the configurations and/or approaches described herein are exemplary in nature, and that these specific embodiments or examples are not to be considered in a limiting sense, because numerous variations are possible. For example, while the above embodiments are described in the context of generating status flags using exclusive OR and addition operations, it will be appreciated that the concepts may be applied in a similar manner to any other suitable arithmetic operations on a sufficient intermediate state.

Furthermore, the specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the exemplary embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A method of simulating processor status flags of a first CPU type on a second CPU type, the method comprising:
adding a first n-bit vector and a second n-bit vector and storing a first result;
performing an exclusive OR operation with the first and second n-bit vectors and storing a second result;
performing an exclusive OR operation with the first result and the second result, and storing a first intermediate state;
casting the first result as a signed integer and storing a second intermediate state; and
setting at least one status flag based on at least one of the first intermediate state, the second intermediate state, and the first result.

2. The method of claim 1, wherein setting the status flag comprises setting a Sign flag as the high bit of the second intermediate state.

3. The method of claim 1, wherein setting the status flag comprises setting a Zero flag by comparing the bits up to the simulated instruction width of the second intermediate state to zero.

4. The method of claim 3, wherein the simulated instruction width is 32-bits.

5. The method of claim 1, wherein setting the status flag comprises setting a Carry flag as the next higher bit than the simulated instruction width in the first intermediate state.

6. The method of claim 1, wherein setting the status flag comprises setting an Overflow flag as the exclusive OR operation of the next higher bit than the simulated instruction width in the first intermediate state and the highest bit of the simulated instruction width in the first intermediate state.

7. The method of claim 1, wherein setting the status flag comprises setting an Auxiliary flag as the 5th bit of the first intermediate state.

8. The method of claim 1, wherein the status flag is a Parity flag set as the exclusive OR of the lower 8 bits of the first result.

9. The method of claim 1, wherein the first CPU type is x86 and the second CPU type is PowerPC.

10. The method of claim 1, wherein first n-bit vector and second n-bit vector are 1-bit vectors.

11. A computer readable medium having computer executable code thereon for simulating processor status flags of a first CPU on a second CPU, the executable code to cause the second CPU to:
perform an arithmetic operation involving a first n-bit variable and a second n-bit variable;
store the result of the arithmetic operation;
generate a carry vector representing the carry-in bits from the arithmetic operation;
generate at least one of a Zero flag, a Sign flag, and a Parity flag from the result of the arithmetic operation; and
generate at least one of a Carry flag, an Overflow flag, and an Auxiliary Carry flag from the carry vector.

12. The computer readable medium of claim 11, wherein to generate at least one of a Carry flag, an Overflow flag, and an Auxiliary Carry flag further comprises to perform an exclusive OR with the result of the arithmetic operation and the carry vector.

13. The computer readable medium of claim 12, wherein the Carry flag is set as the 33^{rd} bit of the result of the exclusive OR, the Overflow flag is set as the exclusive OR of the 33^{rd} and 32^{nd} bits of the result of the exclusive OR involving the arithmetic operation and the carry vector, and the Auxiliary Carry flag is set as the 5^{th} bit of the carry vector.

14. The computer readable medium of claim 11, wherein the first n-bit variable and the second n-bit variable are 32 bit numbers.

15. The computer readable medium of claim 11, wherein the first CPU is x86 and the second CPU is PowerPC.

16. A host computer system for emulating a guest instruction set architecture, the host computer system comprising:
a first general purpose register to add a first number and a second number and store a first result;
a second general purpose register to perform an exclusive OR operation with the first and second numbers and store a second result;
a first memory location to store a first intermediate state vector, wherein the intermediate state vector is the result of an exclusive OR operation between the first result stored in the first general purpose register and the second result stored in the second general purpose register;
a second memory location to store a second intermediate state vector, wherein the second intermediate state vector is the first result in the first general purpose register cast as a signed integer; and
a third memory location to store a third intermediate state vector, wherein the third intermediate state vector is the first result stored in the first general purpose register, wherein the first intermediate state vector, second intermediate state vector, and the third intermediate state vector are used to set at least one status flag.

17. The host computer system of claim 16, further comprising a Sign flag to be set as the high bit of the second intermediate state vector, a Zero flag to be set as the result of a comparison between the third intermediate state vector and zero, and a Parity flag to be set as the exclusive OR of the lower 8 bits of the third intermediate state vector.

18. The host computer system of claim 16, further comprising a Carry flag to be set as the 33^{rd} bit of the first intermediate state vector, an Overflow flag to be set as the exclusive OR of the 33^{rd} and 32^{nd} bits of the first intermediate state vector, and an Auxiliary flag to be set as the 5^{th} bit of the first intermediate state vector.

19. The host computer system of claim 16, wherein the guest instruction set architecture is x86 architecture.

20. The host computer system of claim 16, wherein the third memory location is a lookup table.
